(19) United States
(12) Patent Application Publication
(10) Pub. No.: US 2003/0215676 A1
(43) Pub. Date: Nov. 20, 2003

(54) Magnetic recording medium

(76) Inventors: Yoshiharu Kashiwakura, Nagano (JP); Yoshifumi Ajishi, Nagano (JP); Tetsu Ikegami, Nagano (JP)

Correspondence Address: KANESAKA AND TAKEUCHI, 1423 Powhatan Street, Alexandria, VA, 22314, US

(21) Appl. No.: 10/436,249

(22) Filed: May 13, 2003

(30) Foreign Application Priority Data
May 20, 2002 (JP) 2002-045071

(51) Int. Cl. G11B 5/66

(52) U.S. Cl. 428/694 TP; 428/694 R

(57) ABSTRACT

A magnetic recording medium includes a thin-film layered structure in which at least non-magnetic base layers and a magnetic recording layer are successively formed on a non-magnetic base by sputtering, and a protective layer is continuously formed on the magnetic recording layer by sputtering or CVD. The magnetic recording layer is made of Co alloy, and the non-magnetic base layers have two or more layers made of pure metal or alloy having a bcc structure. Further, a Cr—Mn alloy thin film is interposed between the non-magnetic base layers.

### BACKGROUND OF THE INVENTION AND RELATE ART STATEMENT

The present invention relates to a magnetic recording medium, and more particularly relates to a magnetic recording medium for a storage device or the like of information equipment such as a computer.

In recent years, with an increase in the recording density of a storage device for information equipment, the recording density of a magnetic recording apparatus has also been increased through improvements in a magnetic head for reading and writing information and a magnetic recording medium from and to which information is read and written. To increase the recording density of the magnetic recording medium, it is necessary to improve SNR (signal-to-noise ratio) representing a ratio between signal and noise during reading and writing of an information signal.

The magnetic recording medium usually has a layered structure in which a plurality of thin films is laminated. FIG. 1 is a schematic view showing a layered structure of a conventional magnetic recording medium. In FIG. 1, the conventional magnetic recording medium includes a non-magnetic base 1 (NiP-plated aluminum alloy, glass, or the like), a non-magnetic base layer 2 (Cr alloy or the like), a magnetic recording layer 3 (Co alloy or the like), and a carbon protective layer 4.

In general, the non-magnetic base layer 2 (hereinafter referred to as “the base layer”) is provided for controlling the crystal orientation, and the magnetic recording layer 3 is a layer on which information is written. The carbon protective layer 4 is provided for protecting the magnetic recording layer 3 from friction and other problems occurring due to the sliding movement of a magnetic head. These layers are successively formed on the non-magnetic base 1 made of an aluminum alloy, a glass material, or the like.

A crystal structure has a continuity from the base layer 2 formed on the non-magnetic base 1 up to the magnetic recording layer 3 farthermost from the non-magnetic base 1. In general, the non-magnetic base layer 2 is formed of a metal thin film made of Cr or Cr alloy having the bcc crystal structure or an inter-metallic compound such as Ni—Al. The magnetic recording layer 3 is formed of a magnetic thin film consisting essentially of Co—Cr alloy with several kinds of elements added thereto. The protective layer 4 is formed of a thin film consisting essentially of carbon. These layers are generally formed by sputtering or CVD, which can control thin film characteristics with ease and provide high-quality thin films.

The base layer 2 and the magnetic recording layer 3 are comprised of clusters of fine metallic crystal grains. To improve SNR and the recording density, it is necessary to control the crystal structure of the magnetic recording layer 3. Specifically, it is preferred that the magnetic recording layer 3 has such a crystal structure that the fine crystal grains with little defects are oriented in a predetermined direction. The crystal structure in the base layer 2 formed on the non-magnetic base 1 plays an important role in determining the crystal structure in the magnetic recording layer 2. For this reason, it is essential to control the grain size and crystal orientation of the base layer 2 for improving the recording density of the magnetic recording medium.

For example, in order to obtain consistency in a crystal lattice with the magnetic recording layer, it has been attempted that the base layer is properly alloyed and selectively composed. Alternatively, a base film with a high orientation and a base film with a high lattice consistency are laminated, and other methods have been conventionally adopted. To reduce the crystal grain size in the base layer, a thickness of the base layer is reduced or a gas pressure for forming a film is increased so as to prevent excessive growth of the crystal grains, and these methods have been conventionally adopted.

It is essential to control the crystal structure of the base layer for further improvement in the recording density. According to the conventional methods, however, it is difficult to sufficiently improve the crystal growth and the crystal orientation while reducing the crystal grain size. For example, when the base layer has an extremely thin thickness to reduce the crystal grain size, the crystal orientation is deteriorated due to insufficient growth of the crystals. Also, it is possible to increase a degree of crystallinity through proper selection of compositions and materials. However, it is still necessary to reduce the crystal grain size by reducing the thickness of the base layer, which decreases the crystallinity.

It is therefore an object of the present invention to provide a magnetic recording medium having a base layer structure that can reduce the crystal grain size while obtaining an excellent crystallinity, thereby improving SNR and increasing the recording density.

Further objects and advantages of the invention will be apparent from the following description of the invention.

### SUMMARY OF THE INVENTION

To accomplish the above objects, according to the first aspect of the present invention, a magnetic recording medium includes a thin-film layered structure in which at least nonmagnetic base layer and a magnetic recording layer are successively formed on a non-magnetic base by sputtering, and a protective layer is continuously formed on the magnetic recording layer by sputtering or CVD. The magnetic recording medium is made of Co alloy, and the non-magnetic base layer has two or more layers made of a material selected from pure metal or alloy having a bcc structure. Further, a Cr—Mn alloy thin film is interposed between the non-magnetic base layers.

According to the second aspect of the invention, in the magnetic recording medium according to the first aspect, the nonmagnetic base layer is made of pure Cr or Cr alloy. Further, the Cr—Mn alloy thin film interposed between the non-magnetic base layers contains equal to or less than 20 atomic percent of Mn and has a thickness of 0.5 to 3 nm.

According to the third aspect of the present invention, in the magnetic recording medium according to the first aspect, the non-magnetic base layer is made of pure Cr or Cr alloy. Further, the Cr—Mn alloy thin film interposed between the nonmagnetic base layers contains equal to or less than 30 atomic percent of Mn and has a thickness of 0.5 to 2.5 nm.

As described above, according to the present invention, the non-magnetic base layer has the layered structure comprising a plurality of thin films. The Cr—Mn alloy thin film with a predetermined composition and thickness is interposed between the thin films constituting the non-magnetic base layer. The Cr—Mn alloy thin film contains equal to or less than 20 atomic percent of Mn and has the film thickness of 0.5 to 3 nm, or contains equal to or less than 30 atomic percent of Mn and has the thickness of 0.5 to 2.5 nm. As a result, it is possible to improve SNR and recording density of the magnetic recording medium.

### BRIEF DESCRIPTION OF THE DRAWINGS

FIG. 1 is a schematic view showing a layered structure of a conventional magnetic recording medium;

FIG. 2 is a schematic view showing a layered structure of a magnetic recording medium according to the present invention; and

FIGS. 3(a) and 3(b) are charts showing relationships between signal-to-noise ratio (SNR) and a resolution representing a high frequency characteristic with a thickness of a Cr—Mn layer.

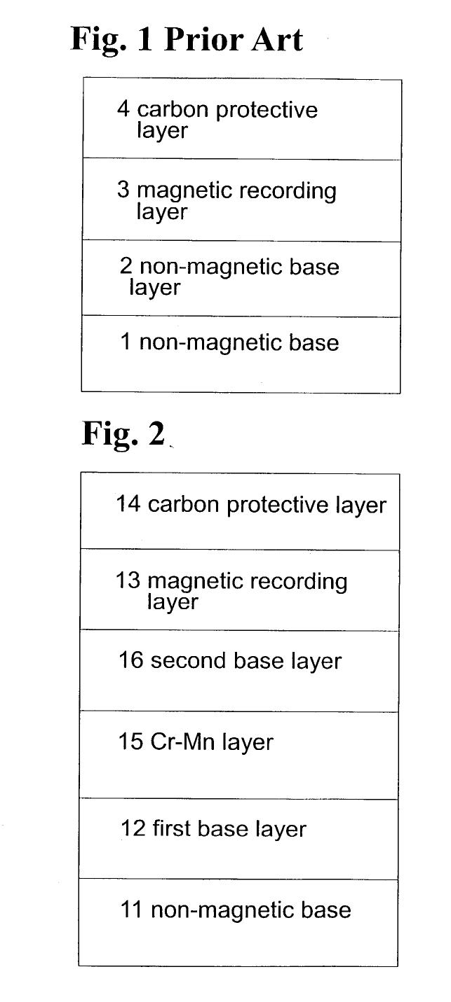

### DETAILED DESCRIPTION OF PREFERRED EMBODIMENTS

Hereunder, embodiments of the present invention will be described in further detail with reference to the accompanying drawings.

FIG. 2 is a sectional view showing a magnetic recording medium according to an embodiment of the present invention. As shown in FIG. 2, the magnetic recording medium includes a nonmagnetic base 11 (NiP-plated aluminum alloy, glass, or the like), a first base layer 12 (pure Cr), a magnetic recording layer 13 (Co-18Cr-12Pt-6B (atomic percent)), a carbon protective layer 14, a Cr—Mn layer 15 (alloy thin film), and a second base layer 16 (Cr-20Mo (atomic percent)).

According to the present invention, the magnetic recording medium has a thin-film layered structure in which at least the non-magnetic base layers 12, 16 and the magnetic recording layer 13 are successively formed on the non-magnetic substrate 11 by sputtering. The protective layer is continuously formed on the magnetic recording layer 13 by sputtering or CVD. The magnetic recording layer 13 is made of a Co alloy. The nonmagnetic base layers 12 and 16 are made of a material selected from pure metal or alloy having the bcc structure, and the Cr—Mn layer (alloy thin film) 15 is interposed between the non-magnetic base layers 12 and 16.

The first base layer 12, Cr—Mn layer 15, second base layer 16, Co alloy magnetic recording layer 13, and carbon protective layer 14 are successively formed by DC magnetron sputtering on the non-magnetic substrate 11 made of an aluminum alloy having a NiP-plated layer textured in the circumferential direction with a mean roughness of 0.5 nm.

The magnetic recording layer 13 made of the aluminum alloy contains Co-18Cr-12Pt-6B (atomic percent) and has a constant film thickness of 15 nm. The first base layer 12 is made of pure Cr having the bcc structure with a high excellent crystal orientation in the circumferential direction of the nonmagnetic substrate 11. The second base layer 16 contains Cr-20Mo (atomic percent) having a crystal lattice interval highly consistent with the magnetic recording medium 13 made of the Co alloy.

The first base layer 12 has a constant film thickness of 7 nm, and the second base layer 16 has a constant film thickness of 3 nm. In the Cr—Mn layer 15, Mn may be selected from 10, 20, or 30 atomic percent. It has been confirmed that the composition of each metal thin film actually formed is substantially identical to the target composition.

The non-magnetic substrate 11 is formed in a doughnut shape with an outer diameter of 95 mm, an inner diameter of 25 mm, and a thickness of 1.0 mm. The carbon protective layer 14 has a film thickness of 5 nm. A constant argon pressure of 5 m Torr is applied during the sputtering. Before the film formation by sputtering, the non-magnetic substrate 11 is heated such that a temperature thereof is about 250° C. just before the formation of the first base layer 12.

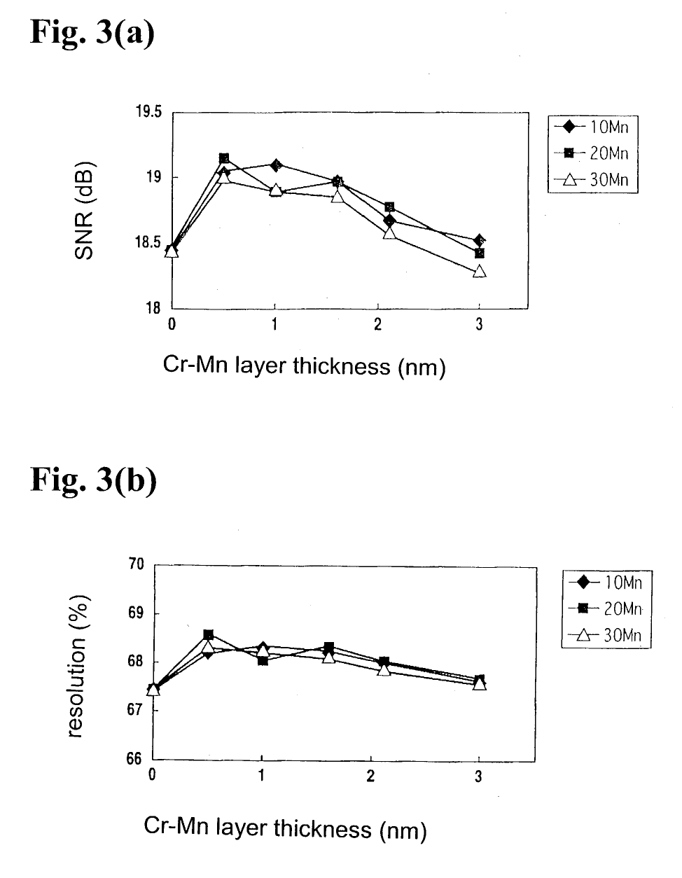

FIGS. 3(a) and 3(b) are charts showing relationships between signal-to-noise ratio (SNR) and a resolution representing a high-frequency characteristic with a thickness of the Cr—Mn layer 15. A spin stand type R/W tester was used for the measurement. A GMR (Giant Magnetic Reluctance) type magnetic head was used as a measuring magnetic head. A measuring radius was 33 mm, a rotational speed of the non-magnetic substrate 11 was 4500 rpm, and a measuring line recording density was 308 kfci.

It is apparent that the Cr—Mn layer 15 with the film thickness of 0.5 nm exhibits an improved SNR as compared with the conventional magnetic recording medium with no Cr—Mn layer (the Cr—Mn layer with the film thickness of 0 nm). Also, it is confirmed that the resolution is increased, or the frequency characteristic is improved, resulting in the higher applicability to a recording density. In each Cr—Mn composition, SNR is lowered with an increase in the film thickness of the Cr—Mn layer 15.

In the case where the Cr—Mn layer 15 contains 10 or 20 atomic percent of Mn, the Cr—Mn layer 15 with the thickness equal to or less than 3 nm exhibits SNR higher than that of the conventional medium. On the other hand, in the case where the Cr—Mn layer 15 contains 30 atomic percent of Mn, the Cr—Mn layer 15 with the thickness equal to or less than 2.5 nm exhibits SNR higher than that of the conventional medium. Accordingly, in the present invention, the upper limit of the film thickness is 3 nm.

It is difficult to obtain a thin film with a uniform film thickness of 3 nm or less with uniform properties. Especially, it is extremely difficult to obtain the Cr—Mn layer 15 with a film thickness of 0.5 nm or less. Therefore, it is not practical to employ a film thickness of 0.5 nm or less in the present embodiment. In view of a productivity, it is preferred that the Cr—Mn layer 15 has a larger film thickness within a range of 0.5 to 3 nm. The film thickness of the Cr—Mn layer 15 is selected according to a required improvement in SNR.

The range of composition of the Cr—Mn layer 15 is limited for the reasons described below. In the case where the Cr—Mn layer 15 contains 30 atomic percent of Mn, the Cr—Mn layer 15 has an applicable range of the film thickness narrower than that of the Cr—Mn layer 15 containing less Mn. More Mn in the Cr—Mn layer 15 further reduces the range of the applicable film thickness of the Cr—Mn layer 15, thereby reducing a production margin. Therefore, in the present embodiment, 30 atomic percent of Mn in the Cr—Mn layer 15 is an upper limit.

It is known that the crystal structure of Mn is a cubic lattice structure in which a plurality of simple bcc lattices is combined. When Mn is added to the bcc crystal such as Cr, the bcc lattice gradually disarrays. It is considered that the disarray in the bcc lattice caused by the addition of Mn lowers SNR. In a case where only a small amount of Mn is added, the crystal lattice disarrays in a less extent. Thus, there is no lower limit of the amount of Mn in the Cr—Mn layer 15.

When the Cr—Mn layer 15 with a film thickness of 1.6 nm contains 10 atomic percent of Mn, it has been confirmed that the magnetic recording medium has an activation volume about 12% smaller than that of the conventional medium. It is known that the activation volume of the magnetic recording medium is approximately equal to a volume of the crystal grain. A smaller activation volume indicates that finer crystal grains are formed. Further, the electron beam diffraction results show that the crystallinity and the crystal orientation are not deteriorated due to the insertion of the Cr—Mn layer 15.

For the observations stated above, it is believed that when the Cr—Mn layer is inserted in the magnetic recording medium, the crystal grain size is reduced without deteriorating the crystallinity or the crystal orientation, thereby improving SNR.

According to the present invention, it is possible to obtain a fine base structure while maintaining the crystallinity. This effect is not lost when an additional layer is formed after the base layer is formed. For this reason, the present invention is applicable to new types of magnetic recording media developed in a variety of fields, such as a magnetic recording medium in which a thin Co alloy film is interposed between a base layer and a magnetic recording layer, a magnetic recording medium having anti-ferromagnetism between two or more magnetic layers with a Ru layer in between, and so forth.

According to the present invention, the non-magnetic base layer has the layered structure comprising a plurality of thin films. The Cr—Mn alloy thin film having a predetermined composition and a thickness is interposed between the thin films, thereby reducing the crystal grain size and improving SNR without deteriorating the crystallinity of the thin films. It is preferred that the Cr—Mn alloy thin film contains 20 atomic percent or less of Mn and has a film thickness of 0.5 to 3 nm. Also, it is preferred that the Cr—Mn alloy thin film contains 30 atomic percent or less of Mn and has a film thickness of 0.5 to 2.5 nm.

While the invention has been explained with reference to the specific embodiments of the invention, the explanation is illustrative and the invention is limited only by the appended claims.

What is claimed is:

1. A magnetic recording medium, comprising:
a non-magnetic base,
a plurality of non-magnetic base layers deposited on the non-magnetic base, and formed of pure metal or alloy having a bcc structure,
a Cr—Mn alloy thin film layer interposed between the plurality of the non-magnetic base layers,
a magnetic recording layer deposited on the plurality of the non-magnetic base layers, and formed of Co alloy, and
a protective layer formed on the magnetic recording layer.

2. A magnetic recording medium according to claim 1, wherein said plurality of the non-magnetic base layers and said magnetic recording layer are sequentially formed by sputtering, and said protective layer is formed by one of sputtering and CVD.

3. A magnetic recording medium according to claim 1, wherein said plurality of the non-magnetic base layers is formed of pure Cr or Cr alloy, and said Cr—Mn alloy thin film layer has a thickness of 0.5 to 3 nm and contains equal to or less than 20 atomic percent of Mn.

4. A magnetic recording medium according to claim 1, wherein said plurality of the non-magnetic base layers is formed of pure Cr or Cr alloy, and said Cr—Mn alloy thin film layer has a thickness of 0.5 to 2.5 nm and contains equal to or less than 30 atomic percent of Mn.
